(19) United States
(12) Patent Application Publication
(10) Pub. No.: US 2013/0069366 A1
(43) Pub. Date: Mar. 21, 2013

(54) SHEAR ELEMENT FOR A COUPLING

(71) Applicants: Leigh Wayne Morrison, Footscray (AU); Kon Lai, Lalor (AU); Matthew Paul King, Ringwood (AU)

(72) Inventors: Leigh Wayne Morrison, Footscray (AU); Kon Lai, Lalor (AU); Matthew Paul King, Ringwood (AU)

(73) Assignee: AUSTRALASIAN STEEL PRODUCTS PTY LTD, Footscray, Victoria (AU)

(21) Appl. No.: 13/702,073

(22) PCT Filed: May 26, 2011
(86) PCT No.: PCT/AU11/00625

§ 371 Date: Dec. 4, 2012

(30) Foreign Application Priority Data
Jun. 4, 2010 (AU) 2010902471
Jun. 11, 2010 (AU) 2010902585
Dec. 13, 2010 (AU) 2010905469
Mar. 16, 2011 (AU) 2011900946

(51) Int. Cl. F16L 17/02; F16C 11/06

(52) U.S. Cl. CPC F16L 17/02; F16C 11/06
USPC 285/339; 403/122

(57) ABSTRACT

A shear element (10, 30, 50, 70, 70A, 90, 90A) for a coupling (110, 112, 114, 150) that couples the ends of high-pressure pipes or high-pressure hoses. The shear element (10, 30, 50, 70, 70A, 90, 90A) includes a plurality of interconnected shear bodies (12, 32, 52, 72, 72A, 92, 92A), each shear body (12, 32, 52, 72, 72A, 92, 92A) including a discrete connector section (14, 34, 54, 74, 74A, 94, 94A) which forms a connection with an adjacent shear body (12, 32, 52, 72, 72A, 92, 92A).

### FIELD OF THE INVENTION

The present invention generally relates to a shear element for a coupling. The invention is particularly applicable for a pipe coupling for high-pressure pipes or hoses and it will be convenient to hereinafter disclose the invention in relation to that exemplary application. However, it is to be appreciated that the invention is not limited to that application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

One type of coupling used to join high pressure pipes and hoses together includes coupling elements connected at the ends of the pipes or hoses and one or more shear elements. Shear elements of this type act as an interference body between the coupling elements which prevents the coupling elements being pulled apart. Such shear elements are also configured to substantially absorb axial movements of high-pressure pipes connected with pressure impact on the high-pressure pipes/hoses and the coupling.

One example of this type of coupling is disclosed in U.S. Pat. No. 7,481,464B2. This patent describes a coupling which includes a pair of coupling elements provided at a respective end of the pipes or hoses, and a cylindrical cuff which includes two shear elements for coupling the pair of coupling elements to the cuff. The shear elements comprise a plurality of steel cylinder bodies threaded onto a steel cable core. Each of the cylinder bodies can freely move along and rotate around the steel cable. Each of the couplings and cuff has a complementary annular groove in which the shear elements are housed. Each pair of coupling elements engages over the cuff and is locked into place by the shear elements. During a pressure impact event, the shear elements are progressively wedged into the annular grooves.

DE7341019U1 discloses another form of shear element which can be used in this type of coupling comprising a plurality of steel cylinder bodies inserted into and held within an elongate tubular sleeve.

Each of the shear elements of U.S. Pat. No. 7,481,464B2 and DE7341019U1 include a plurality of shear bodies held within or threaded on a common connector element. It has been found that the shear bodies in these arrangements can be very difficult to manipulate and/or remove from a coupling if that common connector is badly damaged or broken. This is because the individual shear bodies are no longer interconnected once the common connector is broken.

It would be therefore desirable to provide alternative shear elements for use in these types of couplings.

### SUMMARY OF THE INVENTION

According to a first aspect of the present invention, there is provided a shear element for a coupling that couples the ends of high-pressure pipes or high-pressure hoses. The shear element includes a plurality of interconnected shear bodies, each shear body including a discrete connector section which forms a connection with an adjacent shear body.

A shear element according to the present invention includes a plurality of shear bodies each of which is connected to an adjacent shear element by an individual or discrete connection section. Thus, each shear body remains attached to an adjacent shear body as long as shear bodies connection section remains connected. Damage to one connection section will generally only disconnect the respective adjacent shear bodies to that connection section. The other shear bodies will remain connected to adjacent shear bodies via their individual (undamaged) connection sections.

The connection section linking each adjacent shear body can comprise any suitable arrangement which allows the adjacent shear bodies to move with a suitable degree of freedom relative to one another. In some embodiments, the connector section pivotally connects each shear body to an adjacent shear body. Suitable connection section arrangement includes (but are not limited to) a universal joint, ball and socket connection, hinge connection, clevis assembly, swivel connection, chain connection or the like. In other embodiments, the connector section includes a flexible member integrally joining adjacent shear bodies. Suitable flexible members include (but are not limited to) a flexible cord, a resilient body, tendon like structure, a chain, a flexible wire, coil, spring, a rope or the like.

In some forms, the connection section may be integrally formed with the shear bodies. In other forms, the connection section may be a separate member which is fastened to each shear body. Where the connection section is a separate member, each shear body may include a recess into which an end of the connection section is fastened.

In some forms, each discrete connector section comprises part of an integral connector body passing through each of the shear bodies. Each shear body is fixedly connected to and is spaced apart along that integral connector body. The discrete connector sections are therefore formed between the respective connections between each shear body and the integral connector body. The integral connector body can comprise at least one of a flexible cord, a resilient body, coil, spring, wire or a chain. In some embodiments, the integral connector body is a solid wire. Here, the shear element forms a resilient clip that can be slotted into a coupling. In other embodiments, the integral connector body is a flexible wire.

The shear element is preferably locked onto the coupling through an opening in the coupling. The shear element can therefore further include two distal shear bodies at the distal ends thereof which include a locking arrangement. The locking arrangement can be any arrangement which enable the distal ends of the shear element to be fastened together. Suitable arrangements include (but are not limited to) a loop, hook, projection, button, chain or the like. In some embodiments, the locking arrangement includes a locking body configured to be wedged into a cooperatively shaped recess located at or proximate the opening in the coupling. The locking body can have any suitable shape which can assist wedging the locking body into a cooperatively shaped recess. For example, the locking body could have any suitable polygonal shape. The locking body preferably has at least one tapered or arcuate side, preferably two opposite sides, to assist the body to be wedged into the cooperatively shaped recess. The locking body preferably includes an outer or top end which is configured to sit substantially flush with outer surface of the coupling proximate the opening. The locking body may include one or more seals, preferably fluid tight seals. The locking body may include one or more colour markings to provide a visual indication of function of the seal, coupling or information on the fluid (pressure, temperature, composition or the like) passing through the coupling.

The shear bodies can have any suitable shape which can be flexibly linked to encircle a coupling element. Suitable shear body shapes include (but are not limited to) an elongate arcuate body, a spherical body, a cylindrical body, a rectangular body, a cubic body or the like.

Each shear body can includes a chamfer configured to cooperate with a complementary chamfer located in a groove housing the shear element in a coupling. In use, the complementary chamfers wedge each shear body in the groove when an axial force is applied to the coupling. The chamfer and complementary chamfer can be any suitable shape.

According to a second aspect of the present invention, there is provided a coupling for coupling together ends of high-pressure pipes or high-pressure hoses. The coupling includes a male coupling element and a female coupling element, each of the male and female coupling elements being located or locatable at a respective end of the pipes or hoses to be coupled together. The coupling also includes at least one shear element according to the first aspect of the present invention for coupling a respective pair of coupling elements.

The female coupling element engages over the male coupling element, with the coupling elements being interlocked by the shear element.

Each coupling element preferably has an annular groove. Each annular groove cooperates when the male coupling element is received within the female coupling element to form an annular housing for the shear element. The female coupling element can also include an opening connected with its annular groove through which the shear element can be introduced or removed. In some embodiments, at least one of the annular grooves include a chamfer configured to cooperate with a complementary chamfer on each shear body to wedge each shear body into that annular groove when an axial force is applied to the coupling.

According to a third aspect of the present invention, there is provided a coupling for coupling together ends of high-pressure pipes or high-pressure hoses. The coupling includes a plurality of coupling elements, each coupling element located or locatable at a respective end of the pipes or hoses to be coupled together. The coupling also includes an intermediary joining element which has at least one shear element according to the first aspect of the present invention for coupling a respective pair of coupling elements.

In one embodiment, the intermediary joining element is a cuff which can be received within a pair of coupling elements. The cuff is preferably generally cylindrical and can include a pair of annular grooves. Each annular groove accommodates a respective shear element. Each coupling element preferably has an annular groove corresponding to a respective annular groove of the cuff.

In another embodiment, the intermediary joining element is a sleeve into which the coupling elements can be received. The sleeve is preferably generally cylindrical and includes a pair of annular grooves. Each annular groove accommodates a respective shear element. Each coupling element preferably has an annular groove corresponding to a respective annular groove of the sleeve.

Again, at least one of the annular grooves of the cuff, sleeve or coupling elements can include a chamfer configured to cooperate with a complementary chamfer on each shear body to wedge each shear body into that annular groove when an axial force is applied to the coupling.

The couplings can include seals to provide a fluid tight seal and to prevent contamination entering between radially adjoining coupling sections, sections of the cuff and/or sleeve. In this manner, a tight connection between adjoining radial elements is produced even with slight axial movement between these elements.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a ball and socket type shear element according to one embodiment of the present invention.

FIGS. 2A and 2B provide more detailed views of the connection of the shear element shown in FIG. 1.

FIG. 3 is a perspective view of a flexible connector type shear element according to one embodiment of the present invention.

FIG. 4 provides more detailed views of the connection of the shear element shown in FIG. 3.

FIG. 5 is a perspective view of another flexible connector type shear element according to one embodiment of the present invention.

FIG. 6 provides more detailed views of the connection of the shear element shown in FIG. 5.

FIG. 7A shows a perspective view of one type of arcuate segment shear element according to one embodiment of the present invention; and FIG. 7B shows a more detailed view of the connection of the shear element shown in FIG. 7A.

FIG. 8A shows a perspective view of another type of arcuate segment shear element according to one embodiment of the present invention; and FIG. 8B shows a more detailed view of the connection of the shear element shown in FIG. 8A.

FIG. 9A shows a perspective view of one type of shear element which includes an integral connector body according to one embodiment of the present invention; and FIG. 9B shows a more detailed view of the connection of the shear element shown in FIG. 9A.

FIG. 10A shows a perspective view of another type of shear element which includes an integral connector body according to one embodiment of the present invention; and FIG. 10B shows a more detailed view of the connection of the shear element shown in FIG. 10A.

FIGS. 11A, 11B and 11C provide cross-sectional views of three types of couplings suitable for use with the shear elements according to the present invention, being 11A male-female coupling; 11B sleeve type coupling; and 110 cuff type coupling.

FIG. 12 provides a perspective view of another coupling suitable for use with the shear elements according to the present invention.

FIGS. 13A, 13B and 13C provide a cross-sectional view of the coupling shown in FIG. 12, providing 13A a broad view; 13B a detailed view of a shear element with no axial strain placed on the coupling; and 13C a detailed view of the shear element with axial strain placed on the coupling.

FIG. 14 provides views of two locking bodies for use with a shear element according to the present invention.

FIG. 15 shows the locking bodies of FIG. 14 located in a complementary recess in a coupling for use with the shear elements according to the present invention.

FIG. 16 provides a front view of another type of shear element which includes an integral connector body according to one embodiment of the present invention and a locking body as shown in FIG. 14.

FIG. 17 provides a cross-sectional view of the coupling shown in FIG. 15.

### DETAILED DESCRIPTION

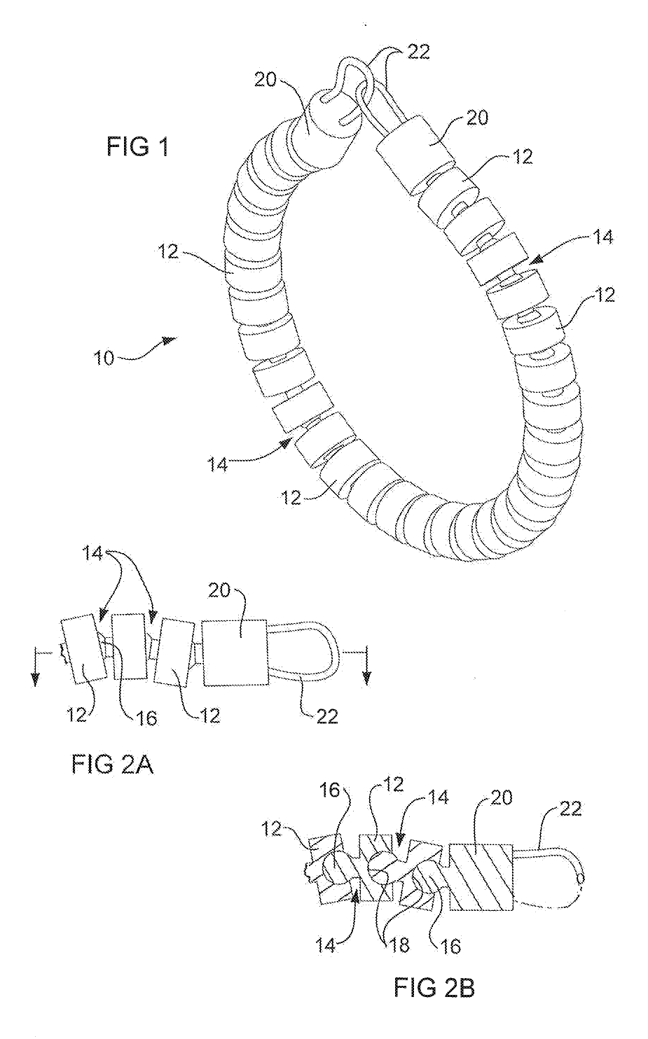

FIGS. 1 and 2 illustrate a ball and socket type shear element 10 according to one embodiment of the present invention. The shear element 10 includes a plurality of interconnected cylindrical shear bodies 12. As best seen in FIGS. 2A and 2B each of these shear bodies 12 are interconnected by a ball and socket joint 14 to provide a flexible array of elements. In this respect, each shear body 12 includes an integrally formed male ball projection 16 and complementary shaped socket 18. Each distal end of the shear element 10 includes a distal shear body 20. Each distal shear body 20 includes only one of the male ball projection 16 or complementary shaped socket 18 and terminates with a locking loop 22. The locking loop 22 allows these distal shear bodies 20 to be locked together when used within a coupling.

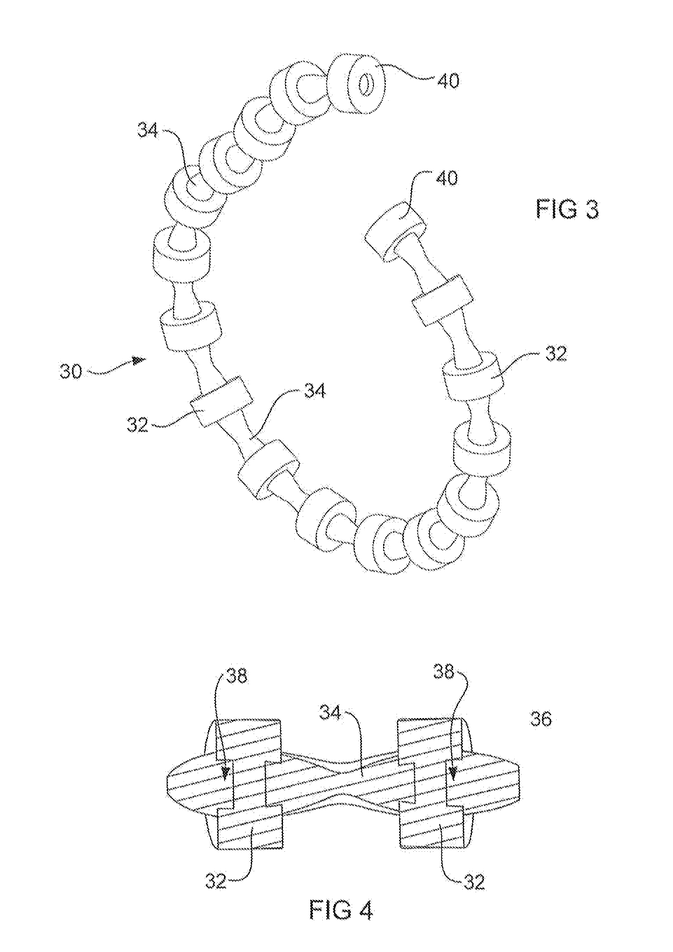

FIGS. 3 and 4 illustrate a flexible tendon type shear element 30 according to one embodiment of the present invention. The shear element 30 includes a plurality of interconnected cylindrical shear bodies 32. As best seen in FIG. 4 each of these shear bodies 32 are interconnected by a flexible tendon 34 to provide a flexible array of elements. The flexible tendon 34 comprises a flexible material such as an elastomer, woven cable, high strength polymer or similar which is fastened between adjacent shear bodies 32. Each shear body 32 can include a recess 36 into which an end section 38 of the flexible tendon 34 is fastened. Each distal end of the shear element 30 includes a distal shear body 40. While not shown in the figures, this distal shear body 40 can include a locking loop or other locking structure such as a hook or chain. The locking structure allows these distal shear bodies 40 to be locked together when used within a coupling.

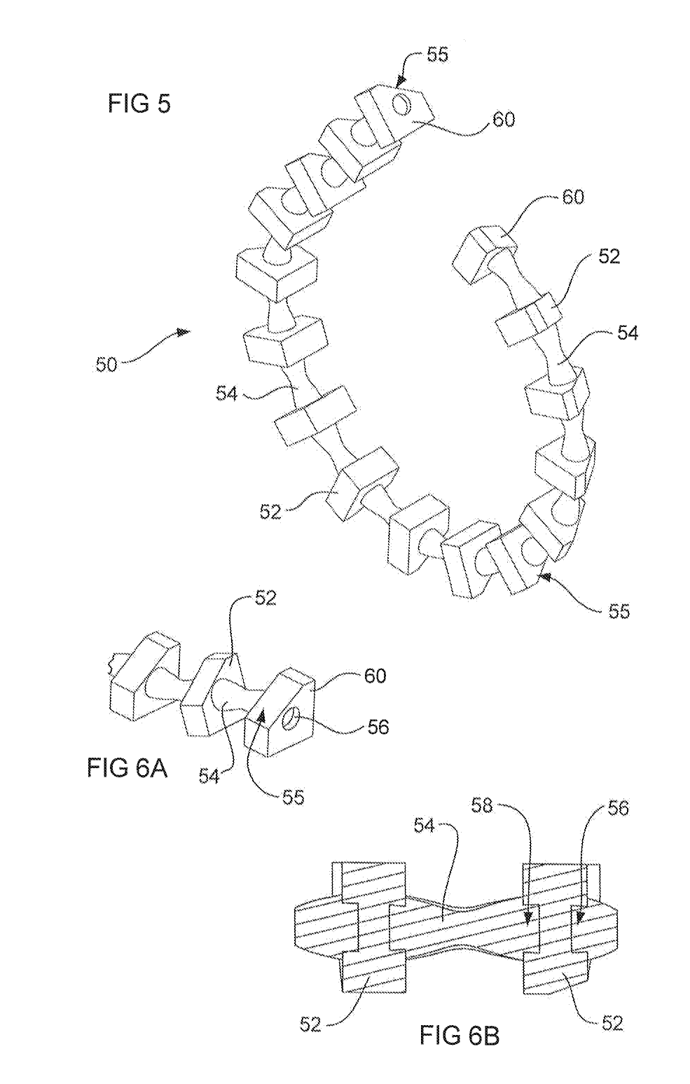

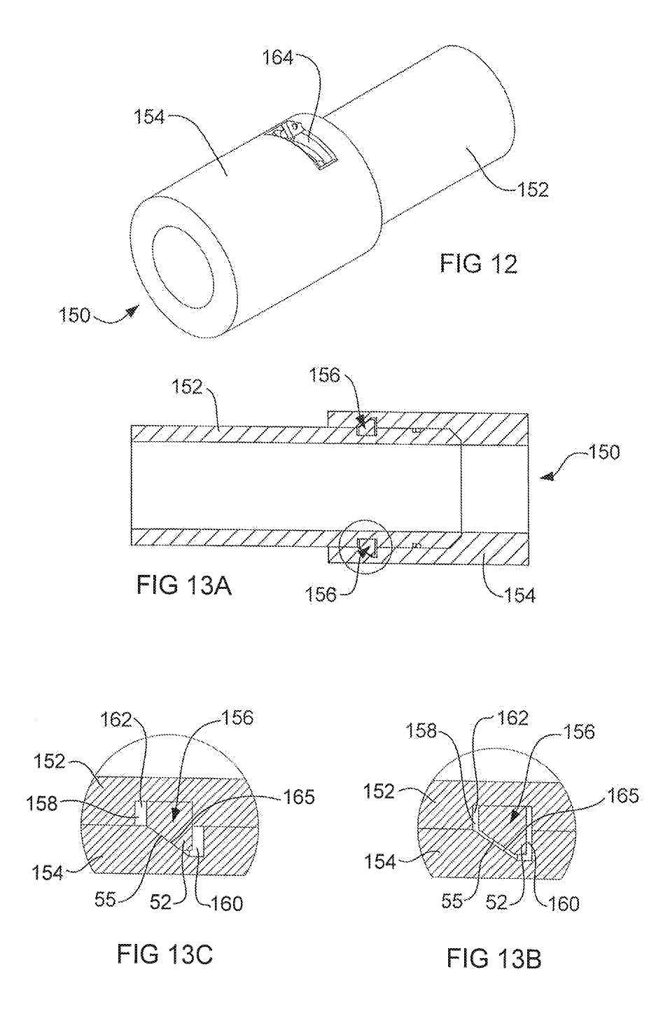

FIGS. 5, 6A and 6B illustrate another form of a flexible tendon type shear element 50 of the present invention. This shear element 50 is similar to the shear element 30 shown in FIGS. 3 and 4. Again, the shear element 50 includes a plurality of interconnected shear bodies 52, but here these shear elements have a polygonal shape. Again, each of the shear bodies 52 is interconnected by a flexible tendon 54. Each shear body 52 includes a recess 56 into which an end section 58 of the flexible tendon 54 is fastened. Again, each distal end of the shear element 50 includes a distal shear body 60 which (whilst not illustrated) may include a locking structure such as a hook or chain. The polygonal shape is a substantially cubic shaped element 52 with a chamfered surface 55 on one side. The chamfer 55 is configured to cooperate with a complementary chamfer located in a groove housing the shear element 52 in a coupling. As will be explained later with reference to FIGS. 12, 13A, 13B and 13C, the complementary chamfers wedge each shear body 52 in the groove when an axial force is applied to the coupling 150.

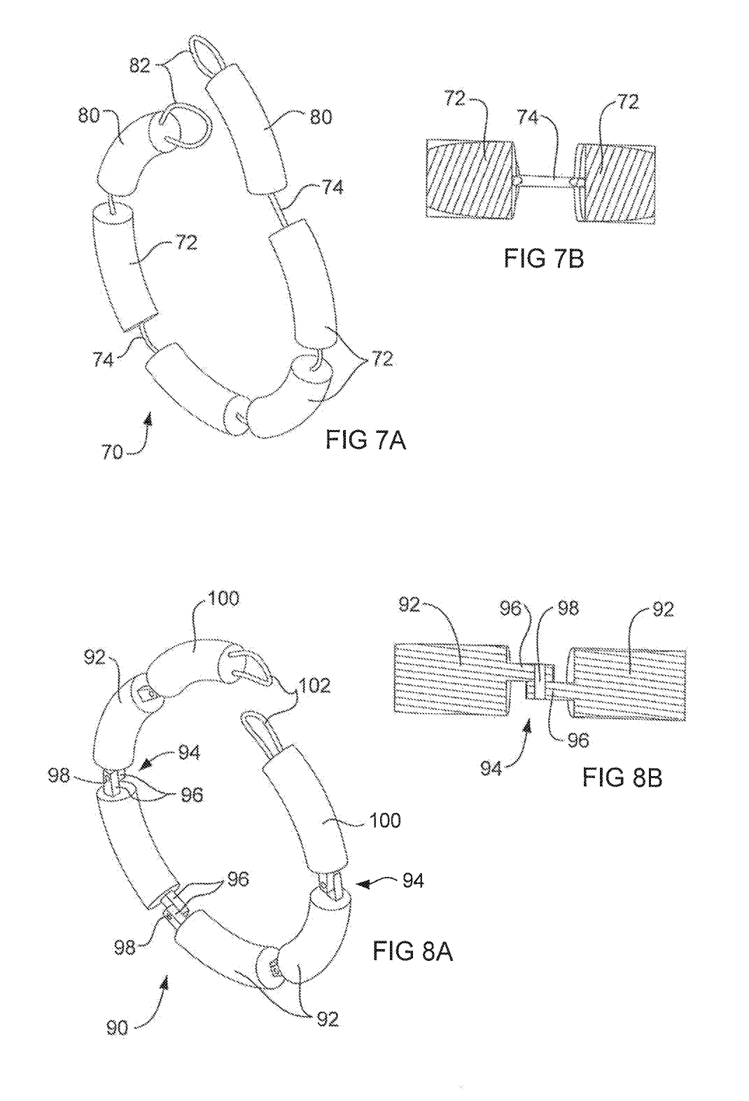

FIGS. 7A, 7B, 8A and 8B illustrate two embodiments of shear element 70, 90 incorporating elongate arcuate shear bodies 72, 92 according to embodiments of the present invention. Each shear element 70, 90 include a plurality of interconnected arcuate cylindrical shear bodies 72, 92. As best shown in FIG. 7B, the shear bodies 72 of the shear element 70 shown in FIG. 7A are interconnected by a flexible cable 74 to provide a flexible array of elements. As best shown in FIG. 8B, the shear bodies 92 of the shear element 90 shown in FIG. 8A are interconnected by a clevis assembly 94 comprising a pair of arms 96 connected through a pivot pin 98. In each embodiment, each distal end of the shear element 70, 90 includes a distal shear body 80, 100. Each distal shear body 70, 90 include a locking loop 82, 102 which allows these distal shear bodies 80, 100 to be locked together when used within a coupling.

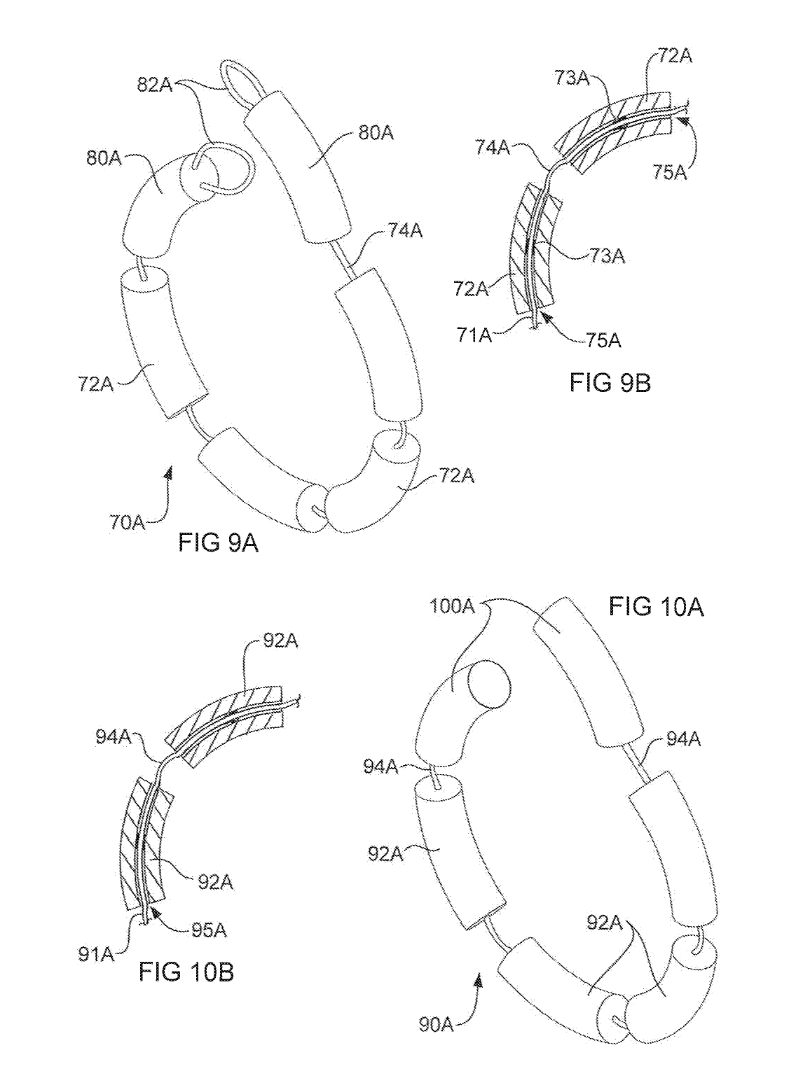

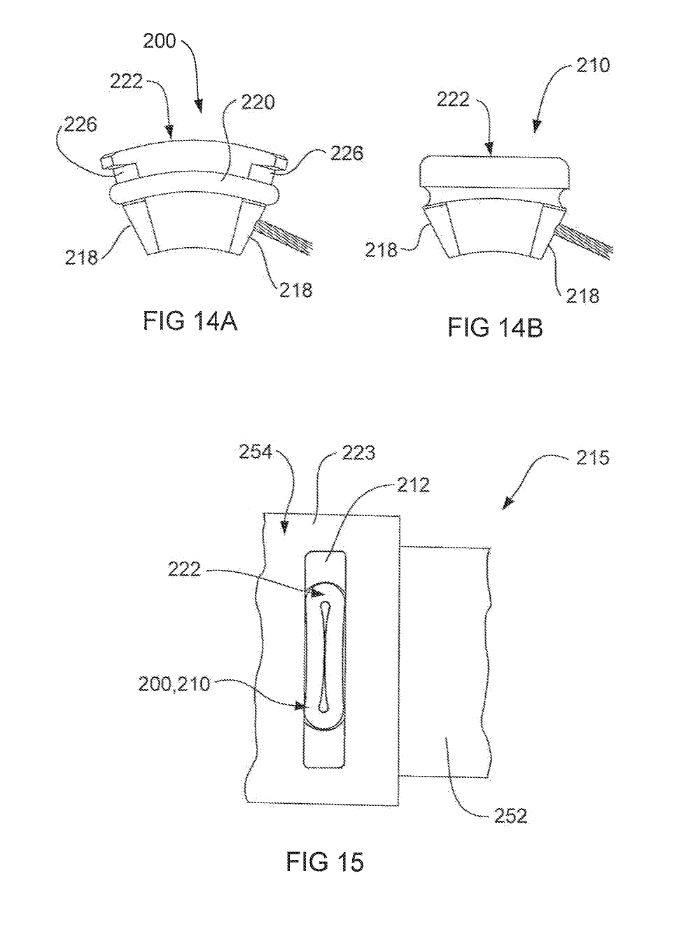

FIGS. 9A, 9B, 10A and 10B illustrate two embodiments of shear element 70A, 90A incorporating elongate arcuate shear bodies 72A, 92A and an integral connector body 71A and 91A passing through each of the shear bodies 72A, 92A. In FIGS. 9A and 9B, the integral connector body is a flexible wire 71A. In FIGS. 10A and 10B, the integral connector body is a solid resilient wire 91 A forming a clip type arrangement. Each shear body 72A, 92A is fixedly connected around and to an integral connector body 71A and 91A in an internal connection 73A and 93A. This may be a weld, adhesive or other fixed connection. This results in each shear body 72A, 92A being spaced apart along that integral connector body 71A and 91A. The discrete connector sections 74A and 94A are therefore formed between the respective connections between each shear body 72A, 92A and the integral connector body 71A and 91A. Each distal shear body 70A, 90A can include a locking arrangement such as locking loop or locking wedge (see FIGS. 14 and 15) which allows these distal shear bodies 80A, 100A to be locked into a coupling when in use.

It should be appreciated that the shear elements and shear bodies of the illustrated embodiments can be constructed of any suitable material including but not limited plastics, metals, ceramics, composites, carbon fibre, or similar.

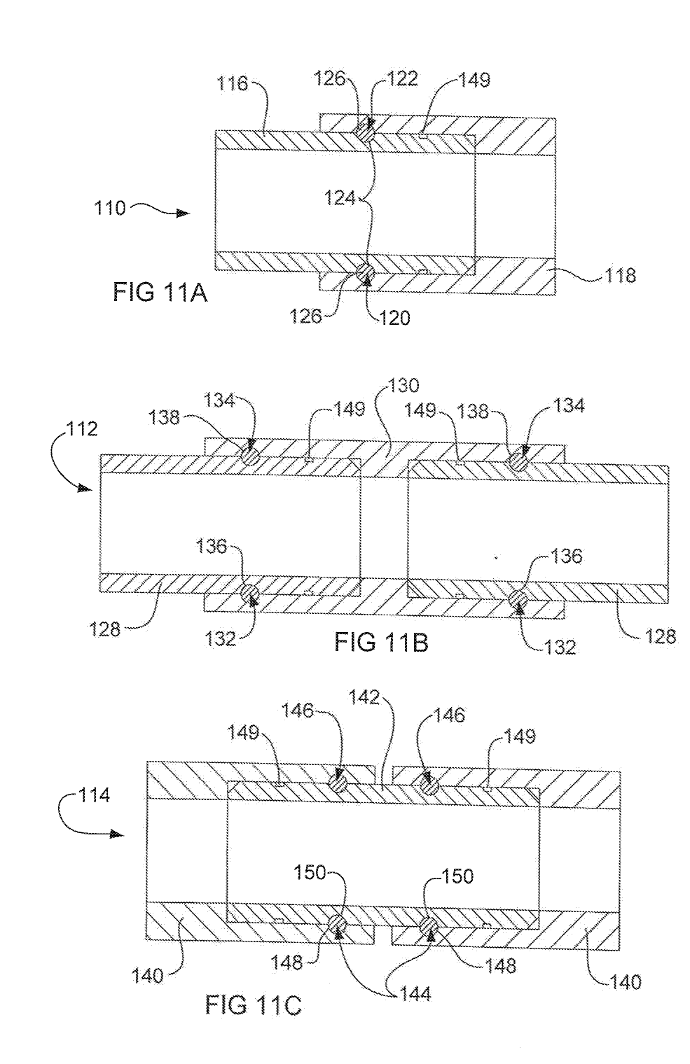

FIGS. 11A, 11B and 11C provide cross-sectional views of three types of couplings 110, 112 and 114 suitable for use with the shear elements shown in FIGS. 1 to 10B.

Firstly referring to FIG. 11A there is shown a male-female coupling 110 for coupling ends of high-pressure pipes or high-pressure hoses. The coupling includes a male coupling element 116 and a female coupling element 118. Each of the male 116 and female 118 coupling elements are provided at a respective end of the pipes or hoses to be connected. The coupling 110 also includes a shear element 120 housed in annular cavity 122 formed from cooperating annular grooves 124 and 126 in the male 116 and female 118 coupling elements. The shear element 120 can be any one of the shear elements shown in FIGS. 1 to 10B. While not shown, the female coupling element 118 also includes an opening connected with its annular groove 126 through which the shear element 120 can be introduced or removed. The female coupling element 118 engages over the male coupling element 116. The coupling elements are interlocked by the shear element 120.

FIG. 11B illustrates a sleeve type coupling 112 for coupling ends of high-pressure pipes or high-pressure hoses. The coupling 112 includes two male coupling elements 128 and a cylindrical intermediary joining sleeve 130 into which the male coupling elements 128 can be received. The coupling 112 also includes a pair of shear elements 132 housed in annular cavities 134 formed from cooperating annular grooves 136 and 138 in the male coupling elements 128 and sleeve 130 respectively. The shear element 132 can be any one of the shear elements shown in FIGS. 1 to 10B. While not shown, the sleeve 130 also includes a pair of openings connected with its two annular grooves 136 through which the shear element 132 can be introduced or removed.

FIG. 11C illustrates a cuff type coupling 114 for coupling ends of high-pressure pipes or high-pressure hoses. The coupling 114 includes two female coupling elements 140 and a cylindrical intermediary joining cuff 142 which is received within the female coupling elements 140. The coupling 114 also includes a pair of shear elements 144 housed in annular cavities 146 formed from cooperating annular grooves 148 and 150 in the female coupling elements 140 and cuff 142 respectively. The shear element 144 can be any one of the shear elements shown in FIGS. 1 to 10B. While not shown, each female coupling element 140 also includes an opening connected with its annular groove 148 through which the shear element 144 can be introduced or removed.

All the couplings shown in FIGS. 11A to 11C include various annular seals 149 to provide a fluid tight seal between radially adjoining coupling sections and sections of the cuff and/or sleeve. In this manner, a tight connection between adjoining radial elements is produced even with slight axial movement between these elements.

FIG. 12, 13A, 13B and 13C illustrate a male-female coupling 150 similar to the coupling 110 described with reference to FIG. 11A. The coupling 150 includes a male coupling element 152 and a female coupling element 154. Each of the male 152 and female 154 coupling elements is provided at a respective end of the pipes or hoses to be connected. The coupling 150 also includes a shear element 156 housed in annular cavity 158 formed from cooperating annular grooves 162 and 160 in the male 152 and female 154 coupling elements. The female coupling element 154 is received over the male coupling element 152. The coupling elements 152, 154 are interlocked by the shear element 156.

The female coupling element 154 includes an opening 164 connected with its annular groove 160 through which the shear element 156 can be introduced or removed. While not illustrated, each distal shear body could include a locking loop or other locking structure which extends out from this opening 164 which allows these distal shear bodies to be locked together, locking the shear element 156 within the annular cavity 158 and the male coupling element 152 and the female coupling element 154 together.

In this embodiment, the shear element 156 comprises the flexible tendon type shear element 50 shown in FIGS. 5, 6A and 6B. This shear element 156 includes shear bodies 52 having a chamfered surface 55 on one side. The chamfer 55 of the shear element 156 is configured to cooperate with a complementary chamfer 165 located in the annular groove 160 of the female coupling element 154. As shown in FIG. 13B, when no axial strain is placed on the coupling 150 the shear element 156 is seated freely within the annular cavity 158. However, once axial strain is applied to the coupling, as shown in FIG. 13C the complementary chamfers 55 and 165 of the shear bodies 52 of shear element 156 and annular groove 160 wedge each shear body 52 in the annular groove 160. Axial strain can be applied by the high-pressure pipe hoses or pipes (attached to the coupling elements 152 and 154) being axially pulled apart due to the pressure that is exerted in the interior of the coupling. The greater the pressure, the greater the wedging effect.

FIGS. 14A and 14B provides views of two locking bodies 200 and 210 for use with a shear element according to the present invention. The locking bodies 200 and 210 function as a retainer to prevent the shear element from coming out of the coupling. Each locking body 200 and 210 comprises a wedge shaped body which can be connected to the end of one distal shear body of a shear element according to the present invention, for example the shear elements 70A and 90A of FIGS. 9 and 10. FIG. 16 shows a shear element 70B which includes a locking body 200 similar to the locking body 200 shown in FIG. 14A.

As best shown in FIG. 15, each locking body 200 and 210 is configured to be wedged into a cooperatively shaped recess located at or proximate the opening 212 in a coupling 215 (described in further detail later in the specification). This forms a positive lock within the cooperatively shaped recess. Each locking body 200 and 210 has shaped sides, in this case tapered sides 218 to assist the body to be wedged into the cooperatively shaped recess. It should be appreciated that this shape could be any suitable shape such as arcuate or the like to provide the locking body with various polygon shapes. The tapered sides 218 also enable the locking body to be rocked in and rocked out of the recess. As shown in FIG. 15, the top end 222 of the locking body 200 and 210 are designed to sit flush with the outer surface 223 of the coupling 215.

As shown in FIG. 14A and FIG. 16, the locking body 200 may include one or more seals 220, preferably fluid tight seals such as an o-ring. The locking body 200 shown in FIG. 14A also includes a lip 226 proximate the top end 222 which can engaged by a tool such as a wedging tool to assist removal of the locking body 200. While not illustrated, it should be understood that the locking body 200, 210 may include one or more colour markings, for example provided as a cap over the top end 222, to provide a visual indication of function of the seal, coupling or information on the fluid (pressure, temperature, composition or the like) passing through the coupling 215. The locking body 200, 210 can also function as a handle for installation and/or removal of a shear element it is attached to from the coupling 215.

FIG. 16 shows a shear element 70B which includes a locking body 200 similar to that shown in FIG. 14A. This shear element 70B is similar to the shear element 70A shown and described in FIG. 9 and incorporates elongate shear bodies 72B and an integral flexible wire connector body 71 B that passes through each of the shear bodies 72B. In this embodiment, the shear bodies 72B have a substantially square cross-section.

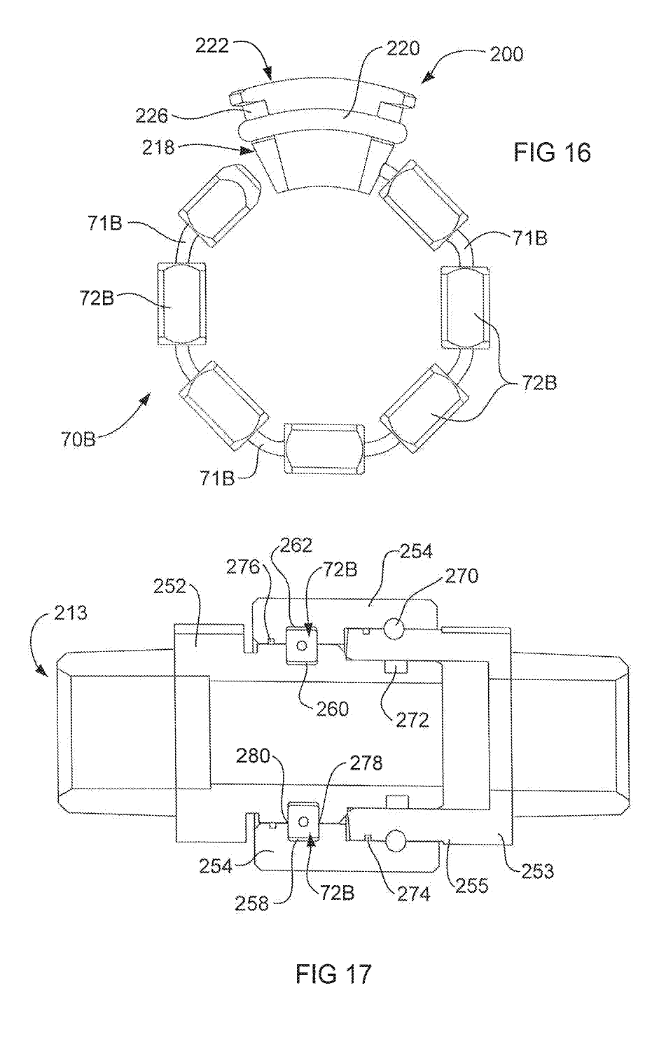

FIG. 17 provides a cross-sectional view of the shear element 70B housed within the coupling 215 shown in FIG. 15. This coupling 215 is a male-female coupling similar to the coupling 110 shown in FIG. 11A. In this case, the coupling 215 includes a male coupling element 252 and a female coupling element 253. Each of the male 252 and female 253 coupling elements can be provided at a respective end of the pipes or hoses to be connected. The female coupling element 253 includes a swivel nut section 254 which is rotatably connected the main body section 255 of the female coupling element 253 through a thrust wire 270. The main body section 255 of the female coupling element 253 connects to the one end of the pipe or hose to be connected. The coupling 215 also includes a shear element 70B housed in annular cavity 258 formed from cooperating annular grooves 260 and 262 in the male 252 coupling elements and swivel nut section 254 of the female 253 coupling elements respectively. The pressure edges 278 and 280 at the join between cooperating annular grooves 260 and 262 in the male 252 coupling elements and swivel nut section 254 of the female 253 coupling elements have a chamfer to substantially prevent a brinelling effect due to pressure loading at these points. This chamfer may be in the form of an arc, polygon or combinations of these. The swivel nut section 254 of the female coupling element 253 is received over the male coupling element 252. The coupling elements 252, 254 are interlocked by the shear element 70B. Environmental seals 274 and 276 are provided between the adjoining sections of the coupling. A pressure seal 272 is also provided between the male coupling element 252 and female coupling element 253.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A shear element for a coupling that couples the ends of high-pressure pipes or high-pressure hoses, the shear element includes a plurality of interconnected shear bodies, each shear body including a discrete connector section which forms a connection with an adjacent shear body.

2. A shear element according to claim 1, wherein the connector section pivotally connects each shear body to an adjacent shear body.

3. A shear element according to claim 2, wherein the pivot connection section comprises at least one of a universal joint, ball and socket connection, hinge connection, clevis assembly, swivel connection, or chain connection.

4. A shear element according to claim 1, wherein the connector section includes a flexible member integrally joining adjacent shear bodies.

5. A shear element according to claim 4, wherein the flexible member comprises at least one of a flexible cord, a resilient body, coil, spring or a chain.

6. A shear element according to any preceding claim 1, wherein the connection section is integrally formed with the shear bodies.

7. A shear element according to claim 1, wherein each discrete connector section comprises part of an integral connector body passing through each of the shear bodies, each shear body being fixedly connected to and being spaced apart along that integral body.

8. A shear element according to claim 7, wherein the integral connector body comprises at least one of a flexible cord, a resilient body, coil, spring, wire or a chain.

9. A shear element according to claim 1, wherein the connection section is a separate member which is fastened to each shear body.

10. A shear element according to claim 7, wherein each shear body includes a recess into which an end of the connection section is fastened.

11. A shear element according to claim 1, further including two distal shear bodies at the distal ends thereof which include a locking arrangement.

12. A shear element according to claim 11, wherein the locking arrangement includes at least one of a loop, hook, projection, button, or chain.

13. A shear element according to claim 11, wherein the locking arrangement includes a locking body.

14. A shear element according to claim 13, wherein the locking body has at least one tapered or arcuate side.

15. A shear element according to claim 1, wherein the shear body comprises at least one of an elongate arcuate body, a spherical body, a cylindrical body, a rectangular body, or a cubic body.

16. A shear element according to claim 1, wherein each shear body includes a chamfer configured to cooperate with a complementary chamfer located in a groove housing the shear element in a coupling to wedge each shear body in the groove when an axial force is applied to the coupling.

17. A coupling for coupling together ends of high-pressure pipes or high-pressure hoses including:
a male coupling element;
a female coupling element, each of the male and female coupling elements being located or locatable at a respective end of the pipes or hoses to be coupled together; and
at least one shear element according to any one of claims 1 to 16 for coupling a respective pair of coupling elements,
wherein the female coupling element engage over the male coupling element, the coupling elements being interlocked by the shear element.

18. A coupling according to claim 17, wherein each coupling element has an annular groove, each annular groove cooperating to form an annular housing for the shear element when the male coupling element is received within the female coupling element.

19. A coupling according to claim 17, wherein the female coupling element includes an opening connected with the annular groove of the female coupling element through which the shear element can be introduced or removed.

20. A coupling according to claim 19, wherein at least one of the annular grooves include a chamfer configured to cooperate with a complementary chamfer on each shear body to wedge each shear body into that annular groove when an axial force is applied to the coupling.

21. A coupling for coupling together ends of high-pressure pipes or high-pressure hoses including:
a plurality of coupling elements, each coupling element located or locatable at a respective end of the pipes or hoses to be coupled together; and
an intermediary joining element including at least one shear element according to any one of claims 1 to 16 for coupling a respective pair of coupling elements.

22. A coupling according to claim 21, wherein the intermediary joining element is a cuff which can be received within a pair of coupling elements.

23. A coupling according to claim 22, wherein the cuff is generally cylindrical and includes a pair of annular grooves, each annular groove accommodating a respective shear element and each coupling element has an annular groove corresponding to a respective annular groove of the cuff.

24. A coupling according to claim 21, wherein the intermediary joining element is a sleeve into which the coupling elements can be received.

25. A coupling according to claim 24, wherein the sleeve is generally cylindrical and includes a pair of annular grooves, each annular groove accommodating a respective shear element and each coupling element has an annular groove corresponding to a respective annular groove of the sleeve.

26. A coupling according to claim 25, wherein at least one of the annular grooves include a chamfer configured to cooperate with a complementary chamfer on each shear body to wedge each shear body into that annular groove when an axial force is applied to the coupling.

27. A coupling according to claim 17, wherein coupling includes an opening into which the shear element is inserted, the shear element includes two distal shear bodies at the distal ends thereof which include a locking arrangement which includes a locking body configured to be wedged into a cooperatively shaped recess located at or proximate the opening in the coupling.

28. A coupling according to claim 27, wherein the locking body includes an outer end which is configured to sit substantially flush with outer surface of the coupling proximate the opening.

29. A coupling according to claim 18, wherein each pair of annular grooves include pressure edges at a join between cooperating annular grooves, each pressure edge having a chamfer to substantially prevent and/or accommodate a brinelling effect due to pressure loading at these edges.

30. A male coupling element configured for coupling to a female coupling element to form a coupling that couples together ends of high-pressure pipes or high-pressure hoses, the male coupling element including an annular groove which, in use, cooperates with a complementary annular groove in a female coupling to form an annular housing for at least one shear element according to any one of claims 1 to 16, the shear element interlocking the male coupling element to the female coupling element.

31. A male coupling element according to claim 30, wherein the annular groove of the male coupling include pressure edges at or proximate a join to the cooperating annular groove of the female coupling element, each pressure edge having a chamfer to substantially prevent and/or accommodate a brinelling effect due to pressure loading at these edges.
